(19) United States
(12) Patent Application Publication
(10) Pub. No.: US 2013/0174086 A1
(43) Pub. Date: Jul. 4, 2013

(54) MULTI-SELECT ROLL OPERATION FOR GRAPHIC APPLICATIONS

(71) Applicants: Aaron K. Baughman, Silver Spriing, MD (US); Barry M. Graham, Silver Spring, MD (US); George R. Langlais, Merrimack, NH (US)

(72) Inventors: Aaron K. Baughman, Silver Spriing, MD (US); Barry M. Graham, Silver Spring, MD (US); George R. Langlais, Merrimack, NH (US)

(73) Assignee: INTERNATIONAL BUSINESS MACHINES CORPORATION, Armonk, NY (US)

(21) Appl. No.: 13/341,249

(22) Filed: Dec. 30, 2011

(51) Int. Cl. G06F 3/048

(52) U.S. Cl. 715/799

(57) ABSTRACT

Embodiments of a system for displaying and rolling a group of objects are described. In one embodiment, the system includes a user interface for displaying a group of objects as well as a system for rolling the group of objects on the display device. The system is configured to detect a user selection of two or more objects displayed on the display device. The system is further configured to recognize a position from 1 through N for each selected object. The system is further configured to receive a command to roll the selected objects, moving each of the objects to their previous or next position depending on the command given.

### BACKGROUND

In graphic and computer drawings applications, it is a common need to rearrange graphics and other objects on a display device. Rearranging objects in a graphic application is oftentimes a tedious and imprecise process as it frequently involves manual rearranging of objects into a specific order. In many conventional applications, rearrangement of objects in a graphical space involves moving objects out of a space, re-ordering or moving objects out of the way, and then re-inserting the removed objects to a different space within the graphical application.

Similarly, even where graphics in a space are arranged correctly in some respects, it is a difficult process to rearrange properties of graphical objects in the same space. Conventional applications include manual movement or adjusting specific properties of individual objects, and in some cases involve recreating an object altogether to rearrange or reorder properties of different graphical objects.

### SUMMARY

Embodiments of a system for displaying and rolling a group of objects are described. In one embodiment, the system includes a user interface for displaying a group of objects as well as a system for rolling the group of objects on the display device. The system is configured to detect a user selection of two or more objects displayed on the display device. The system is further configured to recognize a position from 1 through N for each selected object. The position before 1 is defined as N and the position after N is defined as 1. The system is further configured to receive a command to roll the selected objects, moving each of the objects to their previous or next position depending on the command given. Embodiments of a computer program product and a method are also described.

### BRIEF DESCRIPTION OF THE DRAWINGS

FIG. 1 depicts a schematic diagram of one embodiment of a system for selecting and rolling objects.

FIG. 2A depicts a selection of objects before and after a command to roll the objects has been issued.

FIG. 2B depicts a selection of a group of objects before and after a command to roll the objects has been issued.

FIG. 2C depicts a selection of a fragmented group of objects before and after a command to roll the objects has been issued.

FIG. 3A depicts a group of objects with positional and object attributes before and after a command to roll the objects has been issued.

FIG. 3B depicts a group of objects with positional and varying object attributes before and after a command to roll the objects has been issued.

FIG. 4A depicts a group of objects with multiple attributes before a command to roll the objects has been issued.

FIG. 4B depicts the group of objects with multiple attributes of FIG. 4A after a command to roll the X/Y position of the objects has been issued.

FIG. 4C depicts the group of objects with multiple attributes of FIG. 4A after a command to roll the X/Y position and color of the objects has been issued.

FIG. 4D depicts the group of objects with multiple attributes of FIG. 4A after a command to roll the colors of the objects has been issued.

FIG. 4E depicts the group of objects with multiple attributes of FIG. 4A after a command to roll shapes of the objects has been issued.

FIG. 5 depicts a flowchart of a method for selecting and rolling a group of objects.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments are a system for selecting and rolling a group of objects on a display. A user may select a group of objects, such as graphical objects in a space or displayed on a device, and issue a command to roll the group of objects from a current position to a previous or subsequent position. Upon receiving the command, the objects may rotate to a new position, with each object moving to the previous or next position, and the objects at the ends of the group rolling over to the first or last spot depending on the type of command given. Other embodiments are described in more detail herein.

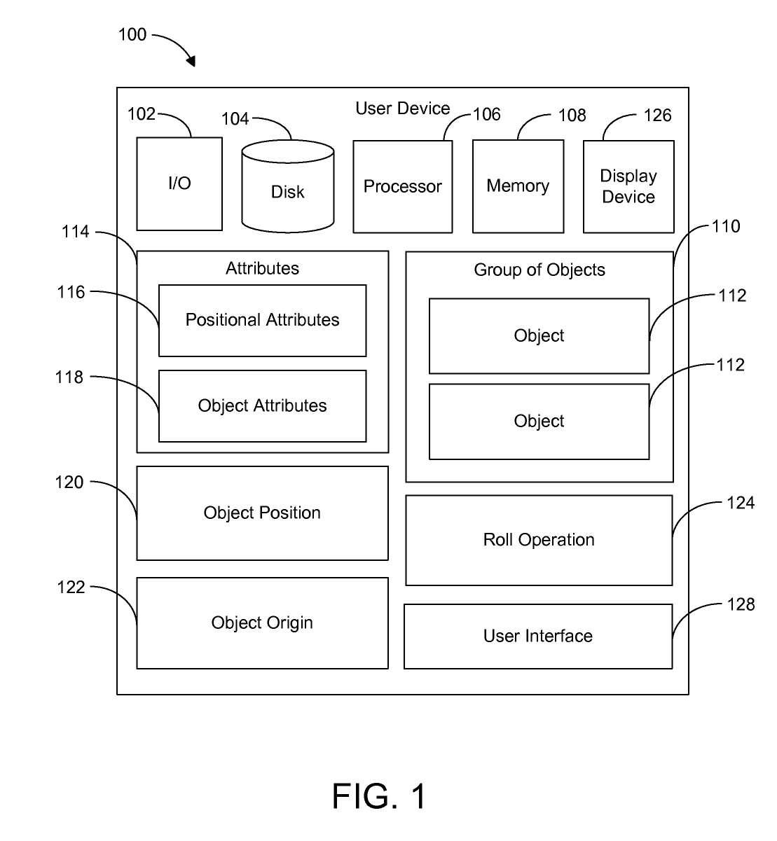

FIG. 1 depicts a schematic diagram of one embodiment of a user device 100 for selecting and rolling objects. The user device 100 includes an I/O interface 102, a disk 104, a processor 106 and memory 108. The user device 100 further includes a display device 126 for displaying objects 112, such as graphical objects or other items to display in a space on a display device 126. The user device 100 also includes a user interface 128. In some embodiments, the user interface 128 may include an I/O interface 102, display device 126 or a combination of other devices for a user to interact with objects 112 displayed on a display device 126. In some embodiments, the objects 112 may be selected as a group of objects 110 and shifted or rolled according to their respective positions 120 on the display. A user may select the objects 110 via a user interface 128 with a device such as a mouse, keyboard, touch screen, or any other object for interacting with a display and selecting a group of objects 110 or items on the display.

In some embodiments, a user may select a group of objects 110 displayed on the display device 126. The group of objects 110 need not necessarily include all of the objects 112 on the display, and may include a subset of a larger number of objects 112. Once the user issues a roll operation 124, each of the objects 112 of the selected group of objects 110 rotates to the next or previous position 120 of each object, according to the type of roll operation 124 issued.

Each of the objects 112 may include a variety of attributes 114 and other properties associated with each object 112 or object position 120. For example, an object 112 may have an attribute 114 or multiple attributes associated with that individual object 112 or with the object's current position. When a roll operation 124 is issued, the positional attributes 116 associated with a specific position 120 are configured to remain with the position 120 and attach to whichever object 112 currently resides in that specific position 120. Likewise, when a roll operation 124 is issued, the object attributes 118 associated with a specific object 112 remain an attribute of that object 112 regardless of the present or final position 120 of that object 112. These object and positional attributes 114 are described in more detail herein.

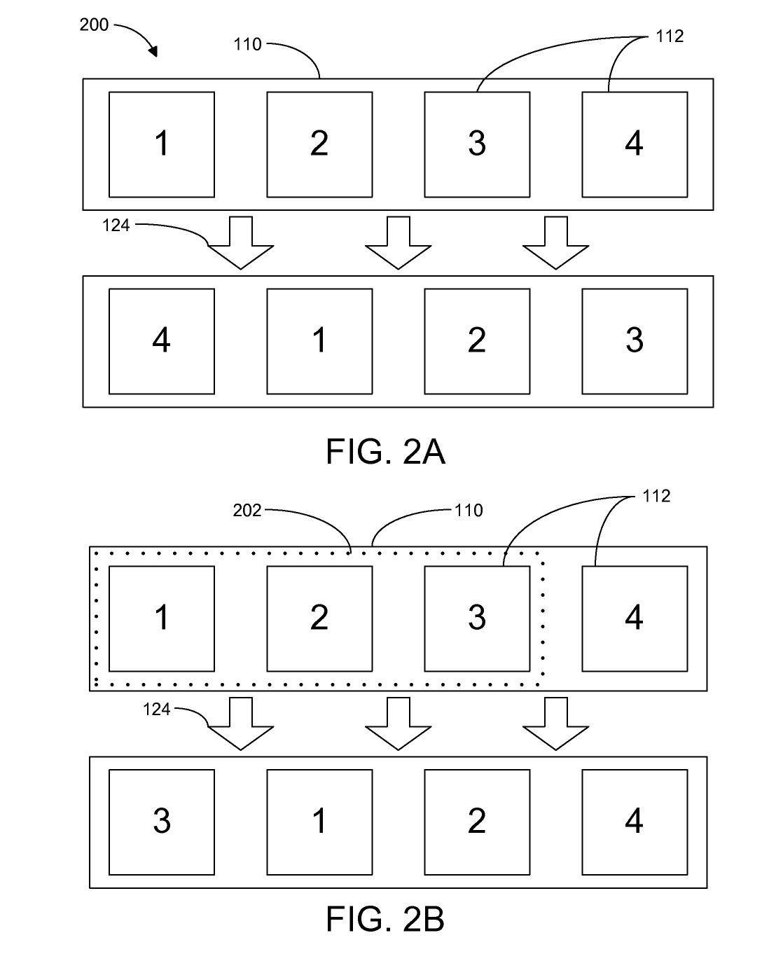

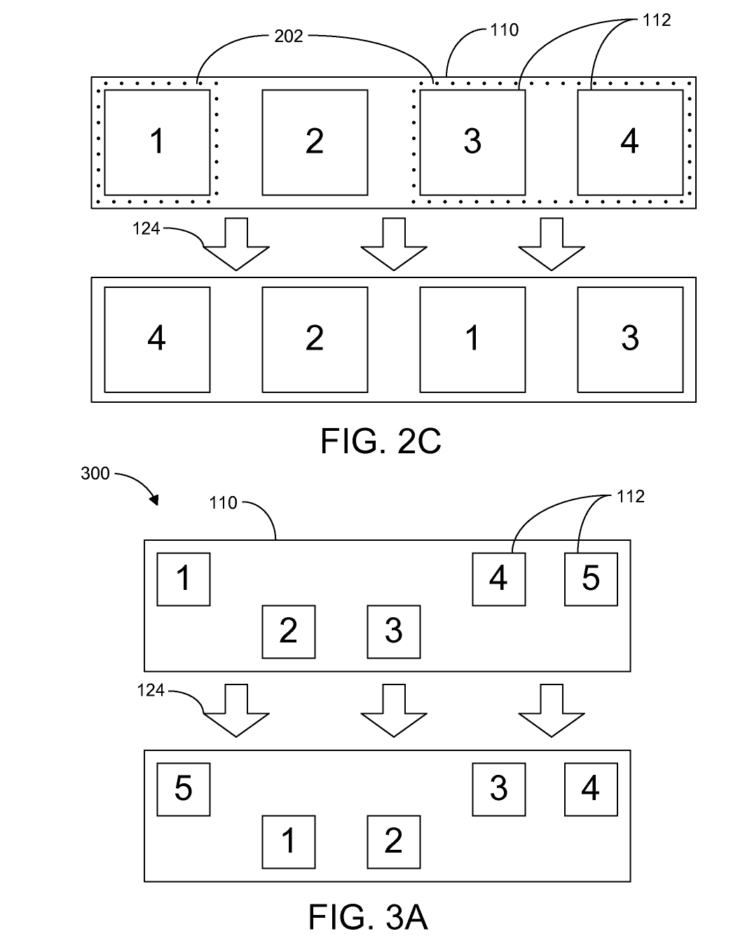

FIG. 2A depicts a selection of objects 112 before and after a command to roll the objects 124 has been issued. Specifically, the illustrated embodiment depicts a roll right operation 200 where a group of objects 112 with assigned positions 120 rolls one spot to the right. Each of the objects 112 is assigned a position 120 from 1 to 4. When the roll operation 124 is performed, the object 112 in the first position rolls to the second position. The object 112 in the second position rolls to the third position. The object 112 in the third position rolls to the fourth position. The object 112 in the fourth position rolls to the first position. In general, a group of objects 110 may have any number of objects 112 assigned to positions 1 through N. In a roll right operation 200 similar to the illustrated embodiment, each of the objects 112 would roll one position to the right, with the Nth object rotating to the first position. If the operation were a roll left operation, each of the objects 112 would roll to the left, with the object corresponding to the first position rolling to the Nth position. In some embodiments, the roll operation 124 may be configured to roll a group of object 112 any number of positions, such as a random or user specified number of positions.

The user device 100 may be configured to roll a selected group of objects 110 in any direction. The illustrated embodiments include directions of right and left. A roll command 124 may be given to roll each of the objects 112 to a next or a previous position, corresponding to either right or left in different embodiments. In some embodiments, the next position refers to the position immediately to the right while the previous position refers to the position immediately to the left of a given object 112. Some embodiments may include any number of reference directions, such as up and down, or backward and forward on a three dimensional axis. A user device 100 may be configured to refer to the next or previous positions 120 as up, down, left, right, in, out, diagonal or any other direction depending on the orientation and assigned order of the objects 112. In some embodiments, a user may insert a roll operation 124 and assign a group of objects 110 to roll forward or backward along multiple reference directions or axes.

FIG. 2B depicts a selection of a group of objects 202 before and after a command to roll the objects 112 has been issued. In the illustrated embodiment, the selected group of objects 202 is a subset of a larger group of objects 110. A user may select the selected group of objects 202 with a mouse, keyboard, touch screen, or other component of a user interface 128. When a roll operation 124 is given, specifically a roll right or roll next operation, the selected group of objects 202 rolls to the right one position. In the illustrated embodiment, only the first three objects 112 roll, with the third object associated with the third and last position of the selected group of objects 202 rolling over to the first position of the group of objects 110. The object 112 corresponding to the fourth position stays in its original position both before and after the roll operation 124 because it is not part of the selected group of objects 202.

FIG. 2C depicts a selection of a fragmented group of objects 202 before and after a command to roll the objects 124 has been issued. The selected group of objects 202 is divided into multiple subsets of a larger group of objects 110. In a selection of objects 202, where each of the objects 112 is not necessarily adjacent in position, the objects 112 roll to the next or previous available position 120 within the selected group of objects 202. For example, in the illustrated embodiment, the object 112 associated with the second position is not selected. Because the object at the second position is not selected when a roll forward command is given, the object 112 in the first position rolls to the third position, skipping the non-selected second position of the larger group of objects 110. Similar to other embodiments, the object 112 associated with the last or fourth position rolls to the first position, or next position in the selected group of objects 202.

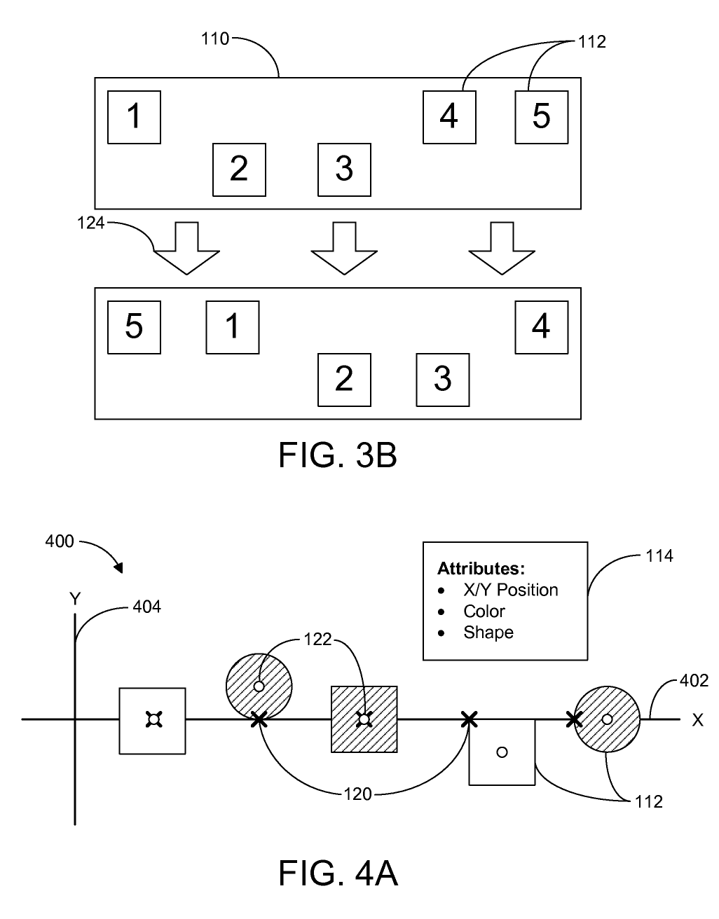

FIG. 3A depicts a group of objects 110 with positional and object attributes 114 before and after a command to roll the objects 124 has been issued. Specifically, the illustrated embodiment depicts a roll right operation 300 where a group of objects 112 with horizontal positions 120 and vertical positional attributes 116 roll one spot to the right. Like previous embodiments, each of the objects 112 are assigned a horizontal position 120. However, each of the positions 120 associated with each object 112 also includes a vertical or Y-component. When a roll operation 124 is given, commanding each of the objects 112 to roll to the right, each object 112 rolls horizontally or in an x-direction to the next position 120. In the illustrated embodiment, each of the positions has a positional attribute 116 which becomes associated with whichever object 112 is assigned to that respective position 120.

In the illustrated figure, the positional attribute 116 is either a Y-High or a Y-Low position. Although this example refers to only two Y values, in other embodiments there may be more than two possible Y values (or X values or other positional values or attributes). By way of example, in FIG. 3A, prior to the roll operation 124, the first position has a positional attribute 116 of Y-High and the second position has a positional attribute 116 of Y-Low. Where the first object associated with the first position has a Y-High attribute 114 when it is in the first position, it then takes on the Y-Low attribute 114 when it moves to the second position, because the positional attributes are associated with the position 120 regardless of which object 112 rests in that position 120. Similarly, each of the other objects 112 rolls to the next position, with each of the objects 112 taking the positional attribute 116 of the next position 120 rather than retaining the attributes 114 of the previous position 120. In further embodiments with more than two possible Y values (or other positional values), each object can take on any or all of the position attributes of the next position to which each object moves.

FIG. 3B depicts a group of objects 110 with positional and varying object attributes 114 before and after a command to roll the objects 124 has been issued. Specifically, the illustrated figure depicts a roll right operation 310 where a group of objects 112 at horizontal positions 120 having object attributes 118 roll one spot to the right. In general, any subset (or an entire set) of available object attributes may be rolled with the objects. However, in this example, only the X value is rolled, and other positional attributes are not rolled with the objects. While each object 112 is associated with a position 120, each of the objects 112 also has an object attribute 118 of a vertical or Y-component. (Note that the Y-component is referred to as an “object attribute” in this example because the attribute stays with the object, rather than the position; in contrast, the Y-component is referred to as a “positional attribute” in the example of FIG. 3A because in that example the Y-component stays with the position, rather than the object.) When a roll operation 124 is given commanding each of the objects 112 to roll to the right, each object 112 rolls horizontally to the next position 120. However, instead of the object 112 taking on a positional attribute 116 associated with a specific position 120, the object 112 retains the vertical Y-component or object attribute 118 associated with each specific object 112. By way of example, in FIG. 3B, prior to the roll operation 124, the first object in the first position has an object attribute 118 of Y-High and the second object in the second position has an object attribute 118 of Y-Low. After the roll operation 124, the first object 112 rolls to the second position retaining its object attribute 118 of Y-High. The second object rolls to the second position and retains it object attribute 118 of Y-Low. Each of the other objects 112 in the group of objects 110 also retains their respective object attribute 118 before and after the roll operation 124.

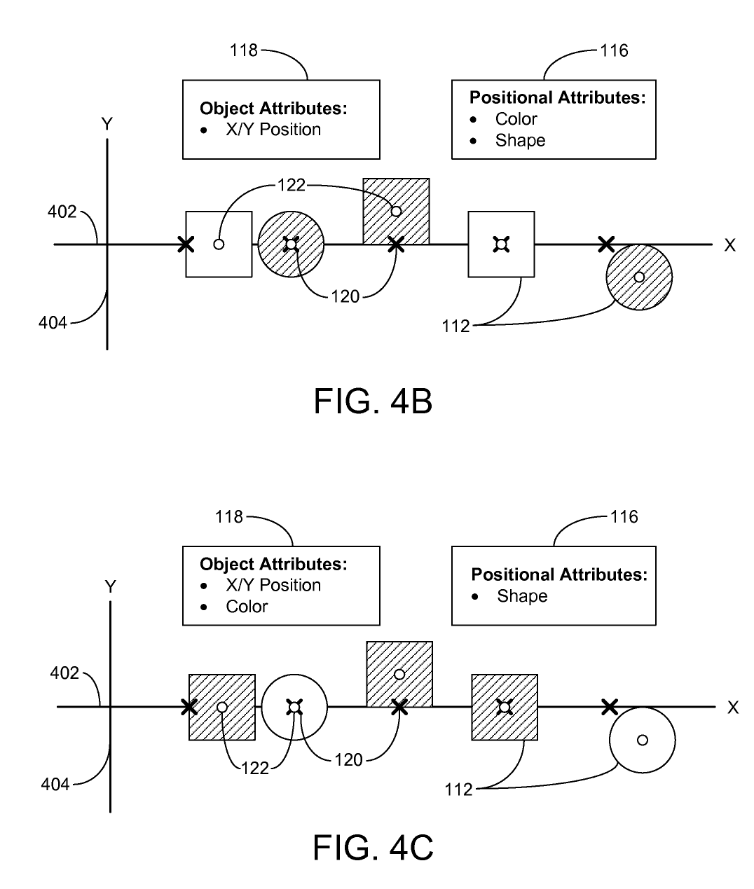

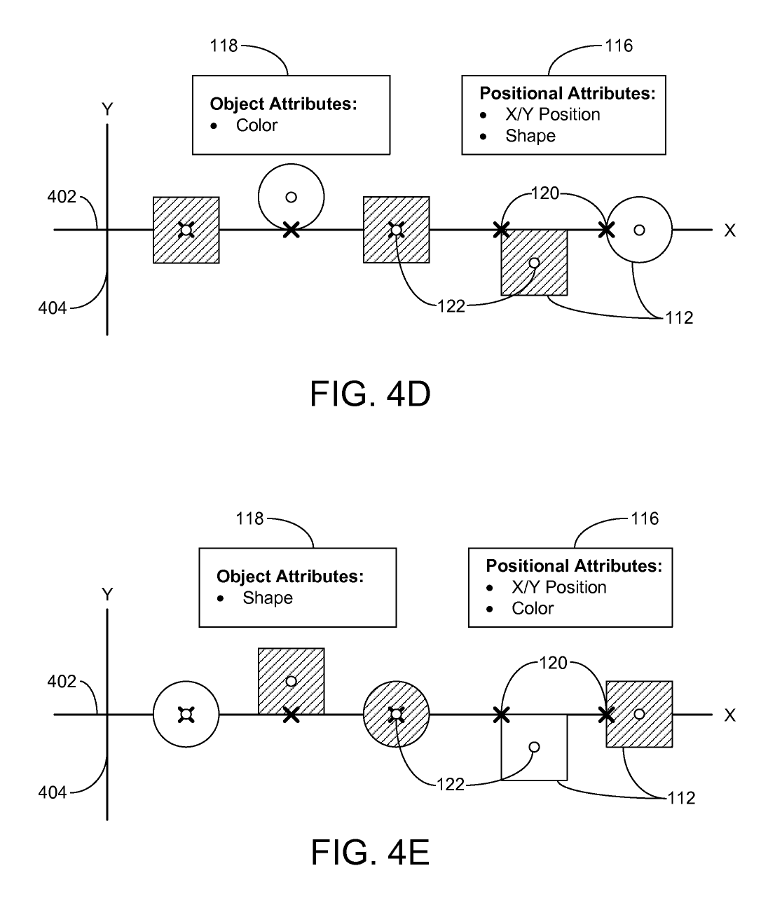

FIG. 4A depicts a group of objects 400 with multiple attributes 114 before a command to roll the objects 124 has been issued. The objects 112 of the illustrated depiction are positioned along an x-axis 402 and a y-axis 404. Each of the objects 112 has multiple attributes 114 associated with either the objects 112 or their corresponding positions 120. While other embodiments may include any number of attributes 114, the attributes 114 of the illustrated embodiment include an X/Y position, a color, and a shape associated with each object 112 or position 120.

Each object 112 is located at a specific position 120 denoted by an “X” along the x-axis 402. In other embodiments, the position 120 may be along a y-axis, z-axis, or any other organizational scheme for ordering a group of objects 110. In addition to being located at a specific position 120, each of the objects 112 has an X/Y offset or coordinate in relation to the position 120. In the illustrated depiction, each X/Y coordinate is centered at an object origin 122 denoted by a circle at each object's center. The order of objects 112 is determined by the location of each object origin 122 according to the roll position 120. For example, if two objects 112 are ordered from left to right, the first roll position will correspond to the left-most object 112.

The X/Y coordinate or attribute 114 of any object 112 may be centered at an object origin 122. In FIG. 4A, the origin 122 of each object 112 is designated by a circle (“o”), which may or may not align with the position 120 (“X”) occupied by the corresponding object 112. The object origin 122 may be the center of an object 112 or may be located at another point, such as the left, corner, gravitational center, or at any arbitrary point in relation to an object 112. In the illustrated embodiments, the object origin 122 is located at the center of each of the objects 112, but may be located elsewhere in relation to the object 112. Further, the object origin 122 may be given a coordinate or position that doesn't line up exactly with the object center or roll position 120. For example, in the illustrated depiction, the first object 112 has an origin 122 centered at the same point as the object position 120. The second object 112 has an origin 122 that lines up with an X/Y position directly above the object 112 or roll position 120. Other objects 112 or object origins 122 may have other X/Y positions or offsets relative to the object or roll position 120.

Each of the objects 112 has an attached set of attributes 114. In the illustrated embodiment, each of the objects 112 has three attributes 114, either associated with the objects 112 as object attributes 118 or associated with the position 120 as positional attributes 116. Additionally, each of the attributes 114 may be set by a user or other input to be either a positional attribute 116 or an object attribute 118. Thus, the designation of certain attributes as either “object attributes” or “positional attributes” determines whether or not certain attributes (i.e., object attributes) roll with an object from one position to the next, or whether or not certain attributes (i.e., positional attributes) remain tied to a position and are applied to any object which occupies that position. The following examples shown in FIGS. 4B-E (as with FIG. 4A) further illustrate how the designation of attributes as either “object attributes” or “positional attributes” affects which attributes are applied to each object at each position within a sequence.

While other embodiments may have any number of attributes 114, the illustrated embodiment includes an X/Y attribute, color attribute, and a shape attribute. The X/Y position may be a combination of an X and Y offset from the object position 120 or it may be offset only in a single X or Y direction. In some embodiments, the X/Y position may be separated into an X and a Y attribute, with an X attribute being a positional attribute 116 and the Y attribute being an object attribute 118 or vice versa. In other embodiments, the X/Y attribute may be a single attribute, denoted by X and Y coordinates along an x- and y-axis 402, 404. Other embodiments may include other axes, such as a z-axis, rotational axis, polar axis, or other position or orientation capable of being displayed on a display device 126.

Table 1 further illustrates the attributes associated with each object 112.

TABLE 1
Objects and Attributes Prior to Command

| | Object | Object | Object | Object | Object |
|---|---|---|---|---|---|
| Attribute | #1 | #2 | #3 | #4 | #5 |
| Shape | Square | Circle | Square | Square | Circle |
| Color | Light | Dark | Dark | Light | Dark |
| X/Y Position | Center | Up | Center | Down/Right | Right |

FIG. 4B depicts the group of objects 400 of FIG. 4A with multiple attributes 114 after a command to roll the objects 124 has been issued. In the illustrated depiction, each of the objects 112 has an object attribute 118 of an X/Y position. Each of the positions 120 has a positional attribute 116 of color and shape. When the roll operation 124 is given, each of the objects 112 rolls to the right with the object in the right-most position rolling to replace the object in the first position. Because each of the objects 112 has an object attribute 118 associated with the X/Y position of the origin 122 in relation to the position 120, the X/Y position of each object 112 remains with the objects 112 as they roll from one position to the next. Because the attributes 114 of color and shape are positional attributes 116, the color and shape of each object 112 remains with the position 120, with objects 112 taking on new attributes associated with the new position 120. The attributes 114 associated with each object 112 and position 120 are further illustrated in Tables 2A and 2B below:

TABLE 2A
Positional and Object Attributes Prior to Command

| Attribute | Object | Object | Object | Object | Object |
|---|---|---|---|---|---|
| Type | #1 | #2 | #3 | #4 | #5 |
| Positional | Square | Circle | Square | Square | Circle |
| Positional | Light | Dark | Dark | Light | Dark |
| Object | Center | Up | Center | Down/Right | Right |

TABLE 2B
Positional and Object Attributes After the Command

| Attribute | Object | Object | Object | Object | Object |
|---|---|---|---|---|---|
| Type | #1 | #2 | #3 | #4 | #5 |
| Positional | Square | Circle | Square | Square | Circle |
| Positional | Light | Dark | Dark | Light | Dark |
| Object | Right | Center | Up | Center | Down/Right |

FIG. 4B further depicts the rolling of objects described in Tables 2A and 2B. In the illustrated figure, each of the objects 112 has an object attribute 118 associated with the X/Y offset in relation to the position 120. Each of the positions 120 has positional attributes of color and shape that remain with the position 120 regardless of the occupying object 112. When the square, white, and centered object 112 originally in the first position (See FIG. 4A) rolls to the second position, the X/Y offset travels with the rolling object 112 while the white and square shape remain with the first position. Other objects 112 within the group of objects 110 also behave similarly. Consequently, the origin 122 of the second object 112 becomes centered around the second position 120 while maintaining the circular shape and dark color positional attributes 116 associated with the second position.

FIG. 4C depicts the group of objects 400 of FIG. 4A with multiple attributes 114 after a command to roll the objects 124 has been issued. In the illustrated depiction, each of the objects 112 has an object attribute 118 of an X/Y position and a color. Each of the positions 120 has an attribute associated with the shape of the object 112. When the roll operation 124 is given, each of the object attributes 118 travels with the associated object 112 to the next position 120, remaining with the object 112 as it rolls. The shape attribute 114, being a positional attribute 116 remains in each respective position 120, with each object 112 taking the shape associated with the new position. The attributes 114 associated with each object 112 and position 120 are further illustrated in Tables 3A and 3B below:

TABLE 3A
Positional and Object Attributes Prior to Command

| Attribute | Object | Object | Object | Object | Object |
|---|---|---|---|---|---|
| Type | #1 | #2 | #3 | #4 | #5 |
| Positional | Square | Circle | Square | Square | Circle |
| Object | Light | Dark | Dark | Light | Dark |
| Object | Center | Up | Center | Down/Right | Right |

TABLE 3B
Positional and Object Attributes After the Command

| Attribute | Object | Object | Object | Object | Object |
|---|---|---|---|---|---|
| Type | #1 | #2 | #3 | #4 | #5 |
| Positional | Square | Circle | Square | Square | Circle |
| Positional | Dark | Light | Dark | Dark | Light |
| Object | Right | Center | Up | Center | Down/Right |

FIG. 4C further depicts the rolling of objects described in Tables 3A and 3B. In the illustrated figure, each of the objects 112 has an object attribute 118 associated with the X/Y offset in relation to the position 120 and the color. Each of the positions 120 has a positional attribute of shape that remains with the position 120 regardless of the occupying object 112. When the square, white, and centered object 112 originally in the first position (See FIG. 4A) rolls to the second position, the X/Y offset and color attributes 114 travel with the rolling object 112 while the square shape remains with the first position. Other objects 112 within the group of objects 110 also behave similarly. Consequently, the second object 112 becomes both white and centered around the second position 120 while maintaining the circular shape positional attribute 116 associated with the second position.

FIG. 4D depicts the group of objects 400 of FIG. 4A with multiple attributes 114 after a command to roll the objects 124 has been issued. In the illustrated depiction, each of the objects 112 has an object attribute 118 of a color. Each of the positions 120 has a positional attribute 116 associated with the shape and X/Y position of the object origin 122. When the roll operation 124 is given, the object attribute 118 of color travels with the objects 112 to the next position 120, remaining with the object 112 as it rolls. The X/Y position of the origin 122 and the shape, being positional attributes 116 remain in each respective position 120, with each object 112 becoming associated with each of the positional attributes 116 of the next position 120. The attributes 114 associated with each object 112 and position 120 are further illustrated in Tables 4A and 4B below:

TABLE 4A
Positional and Object Attributes Prior to Command

| Attribute | Object | Object | Object | Object | Object |
|---|---|---|---|---|---|
| Type | #1 | #2 | #3 | #4 | #5 |
| Positional | Square | Circle | Square | Square | Circle |
| Object | Light | Dark | Dark | Light | Dark |
| Positional | Center | Up | Center | Down/Right | Right |

TABLE 4B
Positional and Object Attributes After the Command

| Attribute | Object | Object | Object | Object | Object |
|---|---|---|---|---|---|
| Type | #1 | #2 | #3 | #4 | #5 |
| Positional | Square | Circle | Square | Square | Circle |
| Object | Dark | Light | Dark | Dark | Light |
| Positional | Center | Up | Center | Down/Right | Right |

FIG. 4D further depicts the rolling of objects described in Tables 4A and 4B. In the illustrated figure, each of the objects 112 has an object attribute 118 of color. Each of the positions 120 has a positional attribute 116 associated with the shape and the X/Y offset in relation to the position 120. Therefore, the X/Y offset and shape remains with the position 120 regardless of the occupying object 112. When the square, white, and centered object 112 originally in the first position (See FIG. 4A) rolls to the second position, the color attribute 114 travels with the rolling object 112 while the X/Y offset and shape remain with the first position. Other objects 112 within the group of objects 110 also behave similarly. Consequently, the second object 112 becomes white while retaining its circular shape and vertical offset associated with the second position.

FIG. 4E depicts the group of objects 400 of FIG. 4A with multiple attributes 114 after a command to roll the objects 124 has been issued. In the illustrated depiction, each of the objects 112 has an object attribute 118 of a shape. Each of the positions 120 has positional attributes 116 associated with the X/Y position of the object origin 122 and color. When the roll operation 124 is given, the object attribute 118 of shape travels with the objects 112 to the next position 120, remaining with the objects 112 before and after the roll command 124 is given. The X/Y position of the origin 122 and the color, being positional attributes 116 remain in each respective position 120, with each object 112 becoming associated with each of the positional attributes of the next position 120. The attributes 114 associated with each object 112 and position 120 are further illustrated in Tables 5A and 5B below:

TABLE 5A
Positional and Object Attributes Prior to Command

| Attribute | Object | Object | Object | Object | Object |
|---|---|---|---|---|---|
| Type | #1 | #2 | #3 | #4 | #5 |
| Object | Square | Circle | Square | Square | Circle |
| Positional | Light | Dark | Dark | Light | Dark |
| Positional | Center | Up | Center | Down/Right | Right |

TABLE 5B
Positional and Object Attributes After the Command

| Attribute | Object | Object | Object | Object | Object |
|---|---|---|---|---|---|
| Type | #1 | #2 | #3 | #4 | #5 |
| Object | Circle | Square | Circle | Square | Square |
| Positional | Light | Dark | Dark | Light | Dark |
| Positional | Center | Up | Center | Down/Right | Right |

FIG. 4E further depicts the rolling of objects described in Tables 5A and 5B. In the illustrated figure, each of the objects 112 has an object attribute 118 of shape. Each of the positions 120 has a positional attribute 116 of color and an X/Y offset in relation to the position 120. When the square, white, and centered object 112 originally in the first position (See FIG. 4A) rolls to the second position, the shape attribute 114 travels with the rolling object 112 while the X/Y offset and color remain with the first position. Other objects 112 within the group of objects 110 also behave similarly. Consequently, the second object 112 becomes a square, while maintaining the dark color and vertical offset as positional attributes 116 associated with the second position.

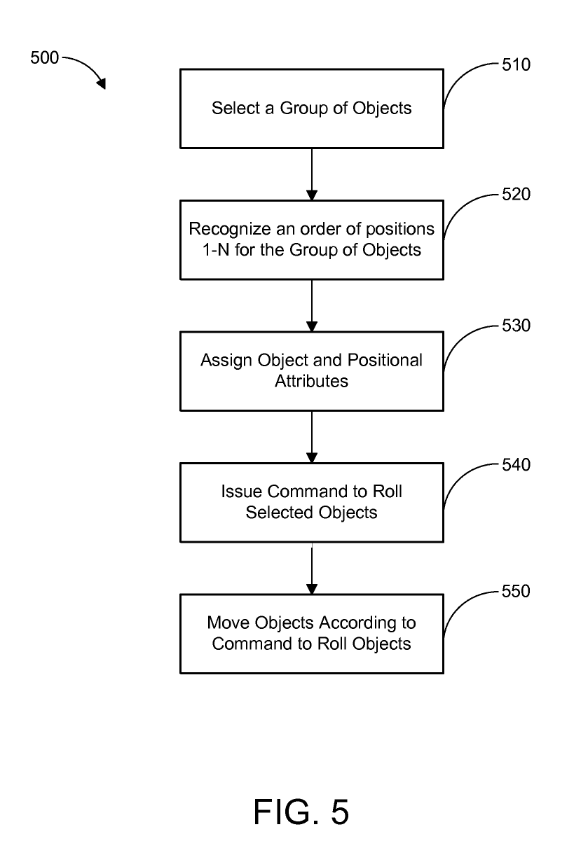

FIG. 5 depicts a flow chart of a method 500 for selecting and rolling a group of objects 110. Although the method 500 is described in conjunction with the system for selecting and rolling objects 112 with components of the user device 100 of described in FIG. 1, embodiments of the method 500 may be implemented with other types of systems for selecting and rolling objects.

A user begins by selecting 510 a group of objects 110 displayed on a display device 126. The objects 112 may be selected with a mouse, touch screen application, keyboard, or any other device capable of selecting objects on a display. A user may select an entire group of objects 110 or any subset of objects 112 within that group 110. The objects 112 may be graphical shapes, icons, entries on a list, or any object 112 displayed on a display device 126.

The user device 100 then recognizes 520 an order of positions 120 for the group of objects 110. In at least one embodiment, the objects 112 may be ordered from left to right along an x-axis with their positions 120 corresponding to the origin 122 of each object 112. Other types of orientations may be used in determining the specific order of objects 112 and corresponding positions 120. The order of selected object positions 120 is defined as 1 through N with N being an integer. Each selected position 120 has a previous and a next position, generally being plus or minus one selected position from the current position 120. For example, in a group of objects 110 where each object 112 is selected, the next position of 1 is 1+1, or 2. The next position of 2 is generally 2+1, or 3, and so forth. The next position of N, being the last position in the group of objects, is defined as 1, making a loop of object positions 120. Similarly, each object position 120 has a previous position. The previous position of N is N−1. The previous position of 2 is 2−1, or 1, and so forth. The previous position of 1, being the first position in the group of objects 110, is defined as N, making a loop of object positions 120.

The user device 100 assigns 530 attributes 114 to be associated with each object 112 and/or positions 120. Positional attributes 116 are associated with a specific position 120 and are configured to remain with the position 120 and attach to whichever object 112 corresponds to that specific position 120. Object attributes 118 are associated with a specific object 112 and remain an attribute of that object 112 regardless of the present position 120 of that object 112.

A user issues 540 a command to roll the selected objects 112, either forward or backward along the chosen orientation. In some embodiments, the command 124 may be a next or previous command associated with any number of directions or orientations. For example, a user may issue a command 124 for objects 112 to roll to the right, left, up, down, forward, backward, diagonal, or other direction in a two or three dimensional field. In some embodiments, a command may be given regarding multiple directions, such as an object 112 oriented on an x, y, and z plane. For example, an object may be commanded to roll both right and down along the x- and y-axes, while remaining constant along the z-axis. This command may be given as part of a user interface 128 that allows a user to select a direction as well as a number of positions 120 to roll. In this way, objects 112 may be commanded to roll any direction by any number of positions 120 as directed by a user input.

The user device 100 then moves 550 the objects 112 and object attributes 118 according to the issued roll operation 124. When a roll command 124 is given, the objects 112 roll to the next or previous position 124 in the selected group of objects 112 and corresponding positions 120. Each of the objects 112 may also have a number of object attributes 118 that remain associated with each object 112 as each object 112 moves to a new position 120. Each position 120 may also have positional attributes 116 that attach to whichever object 112 currently occupies that position 120. In some embodiments, a user may be able to designate a list of attributes 114 as either positional attributes 116 to remain in their assigned positions 120 or as object attributes 118 to roll with each assigned object 112. This selection process may also be part of the user interface 128, allowing a user to easily designate which attributes 114 to assign to objects 112 or positions 120.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a system for selecting and rolling objects includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A computer program product comprising a computer readable storage medium to store a computer readable program that, when executed on a processor within a computer, causes the computer to perform operations for displaying and rolling a group of objects, the operations comprising:
detecting a user selection from an input device of at least two of a plurality of objects displayed on a display device;
recognizing a position from 1 through N for each of the at least two selected objects, wherein each position has a previous and a next position, and wherein the position before 1 is defined as N and the position after N is defined as 1;
receiving a command to roll the at least two selected objects; and
moving each of the at least two selected objects to the previous or next position based on the command to roll the at least two selected objects.

2. The computer program product of claim 1, wherein the computer readable program, when executed on a computer, causes the computer to perform additional operations comprising:
receiving a reference direction for the command to roll the at least two selected objects, wherein the reference direction is an x or y direction in a 2-dimensional field.

3. The computer program product of claim 2, wherein the reference direction is an x, y, or z direction in a 3-dimensional field.

4. The computer program product of claim 1, wherein the computer readable program, when executed on a computer, causes the computer to perform additional operations comprising:
receiving a plurality of reference directions for the command to roll the at least two selected objects;
selecting at least one of the plurality of reference directions; and
moving each of the at least two selected objects to the previous or next position based on the command to roll the at least two selected objects along the at least one selected reference direction.

5. The computer program product of claim 1, wherein each of the at least two selected objects comprises at least one attribute, and wherein the computer readable program, when executed on a computer, causes the computer to perform additional operations comprising:
setting the at least one attribute as a positional attribute, wherein each of the at least two selected objects is configured to comprise the positional attribute of the corresponding position.

6. The computer program product of claim 1, wherein each of the at least two selected objects comprises at least one attribute, and wherein the computer readable program, when executed on a computer, causes the computer to perform additional operations comprising:
setting the at least one attribute as an object attribute, wherein the object attribute is configured to remain with each corresponding object when the at least two selected objects move to the previous or next position

7. The computer program product of claim 1, wherein each of the at least two selected objects comprises a plurality of attributes, and wherein the computer readable program, when executed on a computer, causes the computer to perform additional operations comprising:
setting at least one of the plurality of attributes as a positional attribute, wherein each object is configured to comprise the positional attribute of the corresponding position; and
setting at least one of the plurality of attributes as an object attribute, wherein the object attribute is configured to remain with each corresponding object when the at least two selected objects move to the previous or next position.

8. The computer program product of claim 1, wherein each of the at least two selected objects has an origin, and wherein the position from 1-N of each object is determined by the origin in relation to the origin of the other selected objects.

9. A method for displaying and rolling a group of objects, comprising:
detecting a user selection from an input device of at least two of a plurality of objects displayed on a display device;
recognizing a position from 1 through N for each of the at least two selected objects, wherein each position has a previous and a next position, and wherein the position before 1 is defined as N and the position after N is defined as 1;
receiving a command to roll the at least two selected objects; and
moving each of the at least two selected objects to the previous or next position based on the command to roll the at least two selected objects.

10. The method of claim 9, further comprising:
receiving a reference direction for the command to roll the at least two selected objects, wherein the reference direction is an x or y direction in a 2-dimensional field.

11. The method of claim 10, wherein the reference direction is an x, y, or z direction in a 3-dimensional field.

12. The method of claim 9, further comprising:
receiving a plurality of reference directions for the command to roll the at least two selected objects;
selecting at least one of the plurality of reference directions; and
moving each of the at least two selected objects to the previous or next position based on the command to roll the at least two selected objects along the at least one selected reference direction.

13. The method of claim 9, wherein each of the at least two selected objects comprises at least one attribute, and wherein the method further comprises:
setting the at least one attribute as a positional attribute, wherein each of the at least two selected objects is configured to comprise the positional attribute of the corresponding position.

14. The method of claim 9, wherein each of the at least two selected objects comprises at least one attribute, and wherein the method further comprises:
setting the at least one attribute as an object attribute, wherein the object attribute is configured to remain with each corresponding object when the at least two selected objects move to the previous or next position

15. The method of claim 9, wherein each of the at least two selected objects comprises a plurality of attributes, and wherein the method further comprises:
setting at least one of the plurality of attributes as a positional attribute, wherein each object is configured to comprise the positional attribute of the corresponding position; and
setting at least one of the plurality of attributes as an object attribute, wherein the object attribute is configured to remain with each corresponding object when the at least two selected objects move to the previous or next position.

16. The method of claim 9, wherein each of the at least two selected objects has an origin, and wherein the position from 1-N of each object is determined by the origin in relation to the origin of the other selected objects.

17. A system for displaying and rolling a group of objects, comprising:
a user interface for displaying the group of objects on a display device; and
a system for rolling the group of objects, configured to:
detect a user selection from an input device of at least two of a plurality of objects displayed on the display device;
recognize a position from 1 through N for each of the at least two selected objects, wherein each position has a previous and a next position, wherein the position before 1 is defined as N and the position after N is defined as 1;
receive a command to roll the at least two selected objects; and
move each of the at least two selected objects to the previous or next position based on the command to roll the at least two selected objects.

18. The system of claim 17, wherein the system for rolling the group of objects is further configured to:
receive a reference direction for the command to roll the at least two selected objects, wherein the reference direction is an x or y direction in a 2-dimensional field.

19. The system of claim 18, wherein the reference direction is an x, y, or z direction in a 3-dimensional field.

20. The system of claim 17, wherein the system for rolling the group of objects is further configured to:
receive a plurality of reference directions for the command to roll the at least two selected objects;
select at least one of the plurality of reference directions; and
move each of the at least two selected objects to the previous or next position based on the command to roll the at least two selected objects along the at least one selected reference direction.
